(19) United States
(12) Patent Application Publication
(10) Pub. No.: US 2013/0196258 A1
(43) Pub. Date: Aug. 1, 2013

(54) TONER, DEVELOPER, DEVELOPER CARTRIDGE, IMAGE FORMING APPARATUS, AND IMAGE FORMING METHOD

(71) Applicants: Yoshihiro INABA, Kanagawa (JP); Daisuke YOSHINO, Kanagawa (JP); Akira IMAI, Kanagawa (JP); Takako KOBAYASHI, Kanagawa (JP); Koji HORIBA, Kanagawa (JP); Masahiro OKI, Kanagawa (JP); Ryosaku IGARASHI, Kanagawa (JP)

(72) Inventors: Yoshihiro INABA, Kanagawa (JP); Daisuke YOSHINO, Kanagawa (JP); Akira IMAI, Kanagawa (JP); Takako KOBAYASHI, Kanagawa (JP); Koji HORIBA, Kanagawa (JP); Masahiro OKI, Kanagawa (JP); Ryosaku IGARASHI, Kanagawa (JP)

(73) Assignee: FUJI XEROX CO., LTD., Tokyo (JP)

(21) Appl. No.: 13/556,756

(22) Filed: Jul. 24, 2012

(30) Foreign Application Priority Data
Feb. 1, 2012 (JP) 2012-020073

(51) Int. Cl. G03G 9/00; G03G 15/08

(52) U.S. Cl. 430/105; 430/109.4; 430/114; 430/106.3; 430/106.1; 430/124.1; 399/252

(57) ABSTRACT

A toner includes a binder resin including an amorphous polyester resin (A), a crystalline polyester resin (B), and a polyurethane thermoplastic elastomer (C).

### CROSS-REFERENCE TO RELATED APPLICATIONS

This application is based on and claims priority under 35 USC 119 from Japanese Patent Application No. 2012-020073 filed Feb. 1, 2012.

### BACKGROUND

1. Technical Field

The present invention relates to a toner, a developer, a developer cartridge, an image forming apparatus, and an image forming method.

2. Related Art

From the viewpoint of energy saving, electrophotography has strongly required low-temperature fixability for the purpose of reduction in power consumption in a copying machine, a laser printer, or the like. A binder resin of a low glass transition temperature is used to lower the fixing temperature of a toner.

### SUMMARY

The invention has the following aspects.

According to an aspect of the invention, there is provided a toner including a binder resin including: an amorphous polyester resin (A); a crystalline polyester resin (B); and a polyurethane thermoplastic elastomer (C).

### BRIEF DESCRIPTION OF THE DRAWINGS

Exemplary embodiments of the present invention will be described in detail based on the following figures, wherein:

FIG. 1 is a diagram schematically illustrating an example of the configuration of an image forming apparatus according to an exemplary embodiment of the invention; and

FIG. 2 is a diagram schematically illustrating another example of the configuration of the image forming apparatus according to the exemplary embodiment.

### DETAILED DESCRIPTION

### Toner

A toner according to an exemplary embodiment of the invention includes a binder resin including: an amorphous polyester resin (A); a crystalline polyester resin (B); and a polyurethane thermoplastic elastomer (C).

### Crystalline Polyester Resin (B)

“Crystalline” in the crystalline polyester resin (B) means that a clear endothermic peak instead of a step-like endothermic amount variation is present in differential scanning calorimetry (DSC) of a resin or a toner. Specifically, in the differential scanning calorimetry (DSC) using a differential scanning calorimeter (product name: DSC-60) made by Shimadzu Corporation having an automatic tangent line processing system, a “clear” endothermic peak is present when the temperature from an onset point to the peak top of an endothermic peak is less than 10° C. at the time of raising the temperature at a temperature-rising rate of 10° C./min. From the viewpoint of a sharp melting property, the temperature from the onset point to the peak top of the endothermic peak is preferably less than 10° C. and more preferably less than 6° C. In a DSC curve, a point of a flat part of a base line and a point of a flat part falling from the base line are designated and the intersection of tangent lines of the flat parts between both points is automatically calculated as an “onset point” by the automatic tangent line processing system. The endothermic peak may represent a peak with a width of from 40° C. to 50° C. in case of a toner.

A polymerizable monomer having a linear aliphatic component is more preferably used as a polymerizable monomer component constituting the crystalline polyester resin than a polymerizable monomer having an aromatic component, from the viewpoint of easy formation of a crystal structure. In order not to damage the crystallization, constituent components originating from the polymerizable monomer are preferably contained in the polymer by 30 mol % or more for each species. The crystalline polyester resin necessarily includes two or more species of polymerizable monomers, but each necessary constituent polymerizable monomer has this configuration.

The melting temperature of the crystalline polyester resin is preferably in the range of 50° C. to 100° C., more preferably in the range of 55° C. to 90° C., and still more preferably in the range of 60° C. to 85° C. When the melting temperature is lower than 50° C., toner storage stability or fixed image storage stability after the fixing may degrade, for example, a storage toner may be blocked. When the melting temperature is higher than 100° C., satisfactory lower-temperature fixability may not be achieved. The melting temperature of the crystalline polyester resin is measured as a peak temperature of an endothermic peak obtained through the use of the differential scanning calorimetry (DSC).

The “crystalline polyester resin” in this exemplary embodiment means a polymer having a polyester structure of which the constituent is 100% polyester and also means a polymer (copolymer) obtained by polymerizing components constituting polyester and other components. In the latter, the constituent components other than polyester in the polymer (copolymer) is 50% by weight or less.

The crystalline polyester resin is synthesized, for example, from a polyvalent carboxylic component and a polyol component. In this exemplary embodiment, a commercially-available product may be used as the crystalline polyester resin or a synthetic product may be used.

Examples of the polyvalent carboxylic component include aliphatic dicarboxylic acids such as an oxalic acid, a succinic acid, a glutaric acid, an adipic acid, a suberic acid, an azelaic acid, a sebacic acid, a 1,9-nonanedicarboxylic acid, a 1,10-decanedicarboxylic acid, a 1,12-dodecanedicarboxylic acid, a 1,14-tetradecanedicarboxylic acid, and a 1,18-octadecanedicarboxylic acid; aromatic dicarboxylic acids such as dibasic acids of a phthalic acid, an isophthalic acid, a terephthalic acid, a naphthalene-2,6-dicarboxylic acid, a malonic acid, a mesaconic acid, and the like; anhydrides thereof; and lower alkyl esters thereof, but the polyvalent carboxylic component is not limited to these examples.

Examples of the trivalent or higher carboxylic acid include a 1,2,4-benzene tricarboxylic acid, a 1,2,5-benzene tricarboxylic acid, a 1,2,4-naphthalene tricarboxylic acid, anhydrides thereof, and lower alkyl esters thereof. These examples may be used singly or in combination of two or more.

As the polyvalent carboxylic component, a dicarboxylic component having a sulfonate group may be included in addition to the aliphatic dicarboxylic acid or the aromatic dicarboxylic acid. As the polyvalent carboxylic component, a dicarboxylic component having a double bond may be included in addition to the aliphatic dicarboxylic acid or the aromatic dicarboxylic acid.

As the polyol component, aliphatic diols may be preferably used and straight-chain aliphatic diols of which a carbon number in a main chain is in the range of 7 to 20 may be more preferably used. When the aliphatic diol is branched, the crystallization of the polyester resin may degrade and the melting temperature may be lowered. When the carbon number in the main chain is less than 7, the melting temperature at the time of poly-condensation with the aromatic dicarboxylic acid may be raised. When the carbon number in the main chain is greater than 20, it is difficult to acquire the material in practice. The carbon number in the main chain is more preferably equal to or less than 14.

Specific examples of the aliphatic diol suitably used for synthesis of the crystalline polyester include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol, but the aliphatic diol is not limited to these examples. Among these, in consideration of easy availability, 1,8-octanediol, 1,9-nonanediol, and 1,10-decanediol may be preferably used.

Examples of trihydric or higher alcohol include glycerin, triethylol ethane, trimethylol propane, and pentaerythritol. These examples may be used singly or in combination of two or more.

The content of the aliphatic diol in the polyol component is preferably greater than or equal to 80 mol % and more preferably greater than or equal to 90 mol %. When the content of the aliphatic diol is less than 80 mol %, the crystallization of the polyester resin degrades and the melting temperature is lowered, whereby toner blocking resistance, image storage stability, and lower-temperature fixability may degrade.

If necessary, a polyvalent carboxylic acid or a polyol may be added in the final synthesizing step for the purpose of adjustment of an acid value or a hydroxyl value. Examples of the polyvalent carboxylic acid include aromatic carboxylic acids such as a terephthalic acid, an isophthalic acid, a phthalic anhydride, a trimellitic anhydride, a pyromellitic acid, and a naphthalene dicarboxylic acid; aliphatic carboxylic acids such as a maleic anhydride, a fumaric acid, a succinic acid, an alkenyl succinic anhydride, and an adipic acid; and alicyclic carboxylic acids such as a cyclohexanedicarboxylic acid.

The crystalline polyester resin is prepared at a polymerization temperature of from 180° C. to 230° C., and a reaction system may be depressurized if necessary to remove water or alcohol prepared at the time of condensation.

When the polymerizable monomer is not soluble or compatible at the reaction temperature, a high-boiling-point solvent may be additionally dissolved as a solubilizer. The polycondensation is performed while the solubilizer is distilled. When a polymerizable monomer having poor compatibility in the copolymerization is present, the polymerizable monomer having poor compatibility and an acid or an alcohol to be poly-condensed with the polymerizable monomer are condensed in advance and then the resultant may be poly-condensed with the main component.

Examples of a catalyst used to prepare the polyester resin includes alkaline metal compounds of sodium, lithium, and the like; alkali earth metal compounds of magnesium, calcium, and the like; metal compounds of zinc, manganese, antimony, titanium, tin, zirconium, germanium, and the like; phosphite compounds; phosphate compounds; and amine compounds. The content of the catalyst is preferably in the range of 0.01% by weight to 1.0% by weight with respect to the total content of 100% by weight of the polyvalent carboxylic component and the polyol component and more preferably in the range of 0.1% by weight to 0.6% by weight.

The acid value (the amount in mg of KOH required for neutralizing 1 g of a resin) of the crystalline polyester resin is preferably in the range of 3.0 mg KOH/g to 30.0 mg KOH/g, more preferably in the range of 6.0 mg KOH/g to 25.0 mg KOH/g, and still more preferably in the range of 8.0 mg KOH/g to 20.0 mg KOH/g.

When the acid value is lower than 3.0 mg KOH/g, the dispersibility in water is lowered and it may be thus difficult to prepare emulsified particles through the use of a wet process. Since the stability of the emulsified particles at the time of aggregation is markedly lowered, it may be difficult to efficiently prepare a toner. On the other hand, when the acid value is greater than 30.0 mg KOH/g, the hygroscopicity of the toner may increase and the toner may be easily affected by the environment.

The weight-average molecular weight (Mw) of the crystalline polyester resin is preferably in the range of 6,000 to 35,000. When the weight-average molecular weight (Mw) is less than 6,000, the toner may be infiltrated into the surface of a recording medium such as a sheet of paper at the time of fixation so as to cause uneven fixation or to lower bending resistance of a fixed image. When the weight-average molecular weight (Mw) is greater than 35,000, the viscosity at the time of melting may be excessively raised and the temperature for reaching the viscosity suitable for fixation may be raised, thereby damaging the low-temperature fixability.

The weight-average molecular weight is measured through the use of a gel permeation chromatography (GPC). The molecular weight through the GPC is measured using GPC HLC-8120 made by Tosoh Corporation as a measuring instrument, using TSKgel Super HM-M (15 cm) made by Tosoh Corporation as a column, and using THF as a solvent. The weight-average molecular weight is calculated using a molecular weight calibration curve prepared by the use of a monodispersed polystyrene standard sample from the measurement result.

The content of the crystalline polyester resin in the toner is preferably in the range of 3% by weight to 40% by weight, more preferably in the range of 4% by weight to 35% by weight, and still more preferably in the range of 5% by weight to 30% by weight. When the content of the crystalline polyester is less than 3% by weight, satisfactory low-temperature fixability may not be achieved. When the content of the crystalline polyester resin is greater than 40% by weight, satisfactory toner strength or fixed image strength may not be achieved and an adverse influence on the chargeability may be caused.

The crystalline resin including the crystalline polyester resin preferably includes a crystalline polyester resin synthesized from the aliphatic polymerizable monomer (hereinafter, also referred to as a “crystalline aliphatic polyester resin”) as a main component (50% by weight or more). In this case, the content of the aliphatic polymerizable monomer in the crystalline aliphatic polyester resin is preferably equal to or greater than 60 mol % and more preferably equal to or greater than 90 mol %. The above-mentioned aliphatic diols or dicarboxylic acids may be suitably used as the aliphatic polymerizable monomer.

### Amorphous Polyester Resin (A)

Examples of the amorphous polyester resin (A) used in this exemplary embodiment include resins obtained through the poly-condensation of polyvalent carboxylic acids and polyols.

“Amorphous” in the “amorphous polyester resin” used as the binder resin means that the temperature from an onset point to the peak top of an endothermic peak is greater than 10° C. of a resin or a toner or that a clear endothermic peak is not recognized in the differential scanning calorimetry (DSC). Specifically, in the differential scanning calorimetry (DSC) using a differential scanning calorimeter (product name: DSC-60) made by Shimadzu Corporation having an automatic tangent line processing system, it is “amorphous” when the temperature from an onset point to the peak top of an endothermic peak is greater than 10° C. or a clear endothermic peak is not recognized at the time of raising the temperature at a temperature-rising rate of 10° C./min. The temperature from the onset point to the peak top of the endothermic peak is preferably greater than 12° C. and it is more preferable that a clear endothermic peak be not recognized. The method of calculating the “onset point” in a DSC curve is the same as the method in the “crystalline resin”.

Examples of the polyvalent carboxylic acid are the same as the examples in the above-mentioned crystalline polyester resin (B).

Examples of the polyol in the amorphous polyester resin are the same as the examples in the above-mentioned crystalline polyester resin.

The glass transition temperature (Tg) of the amorphous polyester resin is preferably in the range of 50° C. to 80° C. When Tg is lower than 50° C., toner storage stability or fixed image storage stability may degrade. When Tg is higher than 80° C., low-temperature fixability may degrade. Accordingly, Tg of the amorphous polyester resin is preferably in the range of 50° C. to 80° C.

The amorphous polyester resin is prepared in a way similar to the crystalline polyester resin.

The softening temperature (flow tester half-fall temperature) of the binder resin is preferably in the range of 90° C. to 140° C., more preferably in the range of 100° C. to 135° C., and still more preferably in the range of 100° C. to 120° C., from the viewpoint of improvement of image fixability.

It is preferable that the binder resin be soluble in tetrahydrofuran. Here, the solubility in tetrahydrofuran means that the binder resin is dissolved in tetrahydrofuran when 1 g of the binder resin is added to 10 ml of tetrahydrofuran and the resultant is dispersed at 25° C. for 5 minutes by the use of an ultrasonic disperser.

In the toner according to other exemplary embodiment, the total content of the amorphous polyester resin (A) and the crystalline polyester resin (B) is greater than or equal to about 50% by weight with respect to the total weight of the binder resin. When the total content of the amorphous polyester resin (A) and the crystalline polyester resin (B) is in the above-mentioned range with respect to the total weight of the binder resin, the minimum fixing temperature of the toner is suppressed to be low and the bending resistance with which detachment of toner from a bent portion is suppressed when a recording medium having an image formed thereon is bent is improved.

In the toner according to other exemplary embodiment, the crystalline polyester resin (B) is synthesized from an aliphatic polyvalent carboxylic acid component and an aliphatic polyol component, and the polyurethane thermoplastic elastomer (C) is a thermoplastic polyester urethane synthesized from an organic polyisocyanate and a polyesterdiol.

In the toner according to other exemplary embodiment, the crystalline polyester resin (B) is synthesized from an aliphatic polyvalent carboxylic acid component and an aliphatic polyol component, and the polyurethane thermoplastic elastomer (C) has a structure represented by Formula (I):

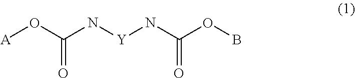

wherein A represents a segment including diisocyanate and glycol, B represents a segment including diisocyanate and polyol, and Y represents the residue of a diisocyanate compound having a urethane bond.

When the crystalline polyester resin (B) and the polyurethane thermoplastic elastomer (C) are set as described above, it is considered that the structures of both are similar and it is thus possible to improve the compatibility of the crystalline polyester resin (B) and the polyurethane thermoplastic elastomer (C) and to improve the compatibility thereof with the amorphous polyester resin (A). It is also considered that it is possible to improve the flexibility of a toner image after being fixed and to suppress the detachment of toner from a bent part when a recording medium having an image formed thereon is bent.

The polyurethane thermoplastic elastomer (C) in this exemplary embodiment is not particularly limited, as long as it is a known thermoplastic polyurethane elastomer. The polyurethane elastomer generally has a soft segment formed through an addition polymerization reaction of long-chained glycol and diisocyanate and a hard segment formed through short-chained glycol and diisocyanate in a molecular structure. Examples of the polyurethane elastomer used in this exemplary embodiment include polyester-based polyurethane elastomers, polyether-based polyurethane elastomers, and polycarbonate-based polyurethane elastomers. From the viewpoint of good maintenance of compatibility/dispersibility with a resin, thermoplastic polyester urethane using polyester-based polyols as a polyol may be preferably used. The thermoplastic polyester urethane is typically a resin formed of a linear polymer obtained by causing an active hydroxyl group of saturated polyester, which is obtained through a condensation reaction of a polybasic acid having two or more carboxyl groups and dihydric alcohol, and an isocyanate group of a diisocyanate compound to react with each other in almost equivalent amounts. As described above, the main chain (polyester part) of polyester polyurethane is not particularly limited, but is preferably the same type as the crystalline polyester resin from the viewpoint of performance. That is, an adipic acid, an azelaic acid, a sebacic acid, a dodecanedloic acid, a terephthalic acid, an isophthalic acid, a phthalic acid, a succinic acid, and the like are used as the polybasic acid, and ethylene glycol, 1,2-propylene glycol, 1,4-butanediol, 1,6-hexanediol, neopentyl glycol, diethylene glycol, triethylene glycol, polyethylene glycol, propylene glycol, polycaprolactone, and the like are used as the dihydric alcohol. Tolylene diisocyanate, diphenylmethane diisocyanate, hexamethylene diisocyanate, xylene diisocyanate, cyclohexylmethane diisocyanate, and the like are used as the diisocyanate compound.

The polyurethane thermoplastic elastomer may have any of a linear chain and a branched chain. The weight-average molecular weight of the polyurethane thermoplastic elastomer is preferably in the range of 5,000 to 500,000 and more preferably in the range of 100,000 to 300,000, from the viewpoint of superior fixability. The reason of restriction to this range is that satisfactory strength is not achieved when the weight-average molecular weight is less than 5,000 and the fixability may degrade when the weight-average molecular weight is greater than 500,000.

Here, as described above, the weight-average molecular weight of the polyurethane thermoplastic elastomer is expressed as a molecular weight in terms of polystyrene through the gel permeation chromatography (GPC) using tetrahydrofuran (THF) as a solvent.

Examples of a commercially-available product of the polyurethane thermoplastic elastomer include “ELASTOLLAN (product name, made by BASF Corporation)”, “PANDEX (product name, made by DIC Bayer Polymer Ltd.)”, “RESAMINE (product name, made by Dainichiseika Color & Chemicals Mfg. Co., Ltd.)”, which are polyurethane thermoplastic elastomer resins. Examples of the commercially-available product of the thermoplastic polyester urethane include PANDEX T-5201, PANDEX T-5206, PANDEX T-5207, PANDEX T-5210, PANDEX T-5210S, and PANDEX T-5265E1 which are made by DIC Corporation and E900 series (E980, E985, E990, and the like), 220M series, and P500 series which are made by Nippon Miractran Co., Ltd., which are all solvent-soluble thermoplastic polyurethane elastomers.

When it is intended to improve image scratch resistance in addition to the bending resistance when a recording medium having an image formed thereon is bent, the content of the polyurethane thermoplastic elastomer (C) is preferably in the range of 5% by weight to 30% by weight with respect to the total content of the binder resin and more preferably 20% by weight. When the toner according to this exemplary embodiment is used as a developer to be described later and refractory oil is used as a carrier liquid, the carrier liquid absorptiveness of the polyurethane thermoplastic elastomer at 25° C. is preferably equal to or less than 100%.

The absorptiveness is a value calculated by the following expression by measuring an increase in weight after inputting 2 g of pellets of a polyurethane thermoplastic elastomer to a 200 ml beaker containing 100 ml of paraffin oil, leaving the beaker in a thermostat container of 25° C. for 15 hours, filtering the resultant with a metallic gauze of 200 meshes, and wrapping the filtered pellets with a filter paper to absorb extra oil.

Absorptiveness (%)=(Increase in Weight)/Initial Weight of Dry Pellets)×100

When the content of the polyurethane thermoplastic elastomer (C) is less than 5% by weight with respect to the total content of the binder resin, the suppression of detachment of toner when a recording medium having an image formed thereon is bent, that is, bending resistance (also referred to as “crease characteristics”) degrades and the offset resistance at high temperatures is damaged. On the other hand, when the content of the polyurethane thermoplastic elastomer (C) is greater than 30% by weight with respect to the total content of the binder resin, scratch resistance (also referred to as “scratch characteristics”), surface smoothness, and transparency of a toner image on a recording medium may degrade. When the carrier liquid absorptiveness of the polyurethane thermoplastic elastomer at 20° C. is greater than 200%, the strength of a fixed image may be lowered and the scratch resistance of the toner image on the recording medium may degrade. Accordingly, the upper limit of the carrier liquid absorptiveness is preferably set to 100%.

The toner according to this exemplary embodiment may include a colorant and other additives such as a release agent, a charge-controlling agent, silica powder, and metal oxide if necessary in addition to the binder resin. These additives may be internally added through the kneading with the binder resin or the like or may be externally added by performing a mixing process after obtaining toner particles.

### Colorant

Known pigments or dyes are used as the colorant in this exemplary embodiment. Specifically, pigments of yellow, magenta, cyan, and black described below are suitably used.

Compounds such as a condensed azo compound, an isoindolinone compound, an anthraquinone compound, an azo metal-complex compound, a methine compound, and an arylamide compound are used as the yellow pigment. Specific examples thereof include C.I. Pigment Yellow 12, C.I. Pigment Yellow 13, C.I. Pigment Yellow 14, C.I. Pigment Yellow 15, C.I. Pigment Yellow 17, C.I. Pigment Yellow 62, C.I. Pigment Yellow 74, C.I. Pigment Yellow 83, C.I. Pigment Yellow 93, C.I. Pigment Yellow 94, C.I. Pigment Yellow 95, C.I. Pigment Yellow 97, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 147, C.I. Pigment Yellow 168, C.I. Pigment Yellow 174, C.I. Pigment Yellow 176, C.I. Pigment Yellow 180, C.I. Pigment Yellow 181, C.I. Pigment Yellow 185, and C.I. Pigment Yellow 191. Among these, C.I. Pigment Yellow 151, C.I. Pigment Yellow 180, and C.I. Pigment Yellow 185 are superior in color reproducibility and do not include halogen and thus do not generate poisonous gas at the time of combustion.

A condensed azo compound, a diketo-pyrrolo-pyrrole compound, an anthraquinone compound, a quinacridone compound, a basic dye lake compound, a naphthol compound, a benzimidazolone compound, a thioindigo compound, and a perylene compound are used as the magenta pigment. Specifically, pigments such as C.I. Pigment Red 2, C.I. Pigment Red 3, C.I. Pigment Red 5, C.I. Pigment Red 6, C.I. Pigment Red 7, C.I. Pigment Red 23, C.I. Pigment Red 48:2, C.I. Pigment Red 48:3, C.I. Pigment Red 48:4, C.I. Pigment Red 57:1, C.I. Pigment Red 81:1, C.I. Pigment Red 122, C.I. Pigment Red 144, C.I. Pigment Red 146, C.I. Pigment Red 166, C.I. Pigment Red 169, C.I. Pigment Red 177, C.I. Pigment Red 184, C.I. Pigment Red 185, C.I. Pigment Red 202, C.I. Pigment Red 206, C.I. Pigment Red 220, C.I. Pigment Red 221, and C.I. Pigment Red 254 are suitably used. Among these, C.I. Pigment Red 122 of the quinacridone pigment is superior in color reproducibility and do not include halogen and thus do not generate poisonous gas at the time of combustion.

A copper phthalocyanine compound and derivatives thereof, an anthraquinone compound, and basic dye lake compound, and the like are used as the cyan pigment. Specifically, C.I. Pigment Blue 1, C.I. Pigment Blue 7, C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 60, C.I. Pigment Blue 62, C.I. Pigment Blue 66, and the like are suitably used. Among these, C.I. Pigment Blue 15:3 is superior in color reproducibility and do not include halogen and thus do not generate poisonous gas at the time of combustion. Carbon black, aniline black, acetylene black, iron black, and the like are suitably used as the black pigment.

### Release Agent

The release agent is not particularly limited, and examples thereof include plant waxes such as carnauba wax, sugar wax, and wooden wax; animal waxes such as honey wax, insect wax, whale wax, and wool wax; and synthetic hydrocarbon waxes such as Fischer-Tropsch wax (FT wax) having ester in a side chain, polyethylene wax, and polypropylene wax. Among these, from the viewpoint of dispersibility, the FT wax having ester in a side chain or the polyethylene wax is preferably used. However, the release agent is not limited to these examples, and these release agents may be used singly or in combination of two or more.

The melting point of the release agent is preferably equal to or higher than 60° C. and more preferably equal to or higher than 70° C., from the viewpoint of storage stability. From the viewpoint of offset resistance at low temperatures, the melting point is preferably equal to or lower than 110° C. and more preferably equal to or lower than 100° C. From the viewpoint of offset resistance at high temperatures, a release agent with a melting point of 100° C. or higher is together used.

The content of the release agent is preferably in the range of 1% by weight to 30% by weight with respect to 100% by weight of the binder resin and more preferably in the range of 2% by weight to 20% by weight. When the content of the release agent is less than 1% by weight, the effect of addition of the release agent is not sufficient and thus hot offset may be caused at high temperatures. On the other hand, when the content of the release agent is greater than 30% by weight, the mechanical strength of the toner degrades and thus the toner may be easily destroyed with a stress in a developing device, thereby causing carrier contamination.

### Other Additives

If necessary, other additives such as a charge-controlling agent, silica powder, and metal oxide and various internal additives or external additives are added to the toner according to this exemplary embodiment.

### Charge-Controlling Agent

The charge-controlling agent is not particularly limited, and known charge-controlling agents are used. Examples thereof include positively-charging charge-controlling agents such as a nigrosine dye, a fatty acid-modified nigrosine dye, a fatty acid-modified nigrosine dye containing a carboxyl group, a quaternary ammonium salt, an amine-based compound, an amide-based compound, an imide-based compound, and an organic metal compound; and a negatively-charging charge-controlling agent such as a metal complex of an oxycarboxylic acid, a metal complex of an azo compound, a metal complex dye, and a salicyclic acid derivative. The charge-controlling agents may be used singly or in combination of two or more.

### Metal Oxide

The metal oxide is not particularly limited, and examples thereof include titanium oxide, aluminum oxide, magnesium oxide, zinc oxide, strontium titanate, barium titanate, magnesium titanate, and calcium titanate. The metal oxides may be used singly or in combination of two or more.

The toner according to this exemplary embodiment is prepared through the use of methods of producing a known pulverized toner, a submerged emulsified and dried toner, a pulverized toner from submerged precipitation, or a so-called chemical toner accompanying with aggregation and unification of emulsified particles. For example, a binder resin, a colorant, and other additives if necessary are input to a mixer such as a Henschel mixer and are mixed therein, the mixture is melted and kneaded with a twin screw extruder, is cooled with a drum flaker or the like, is coarsely pulverized with a pulverizer such as a hammer mill, is finely pulverized with a pulverizer such as a jet mill, and is classified by the use of a wind power classifier, whereby pulverized toner is obtained. A binder resin, a colorant, and other additives if necessary are dissolved in a solvent such as ethyl acetate, the resultant is emulsified/suspended to which a dispersion stabilizer such as calcium carbonate is added, and particles obtained by removing the solvent and removing the dispersion stabilizer are filtered and dried, whereby a submerged emulsified and dried toner is obtained. A binder resin, a colorant, and other additives if necessary are dissolved in a solvent such as a THF, a toluene, and a DMF, the resultant is dropped into a poor solvent such as alcohol by deposition-precipitation, the obtained precipitates are filtered and dried, and the resultant is pulverized and classified as in the above-mentioned pulverized toner, whereby a toner is obtained. A composition including a polymerizable monomer, a colorant, a polymerization initiator (such as benzoyl peroxide, lauroyl peroxide, isopropylperoxy carbonate, cumene hydroperoxide, 2,4-dichlorobenzoyl peroxide, and methylethyle ketone peroxide), and other additives constituting a binder resin is added to an aqueous phase with stirring, is granulated, and is polymerized, and then the resultant particles are filtered and dried, whereby a polymer toner is obtained. Other examples of the method of producing a toner include a method of emulsifying toner materials dissolved in a solvent with a phase inversion in a poor solvent, aggregating and pelletizing the emulsified material with an aggregating agent or a salt, and removing the solvent and a method of mixing emulsified materials of toner materials and aggregating the resultant with an aggregating agent or a salt to obtain particles. The mixing ratios of the materials (the binder resin, the colorant, and other additives) at the time of obtaining the toner are not particularly limited, but may be appropriately set using known techniques.

### Characteristics of Toner Particles

The volume-average particle diameter D50v of toner particles is, for example, in the range of 0.5 μm to 5.0 μm, preferably in the range of 0.8 pinto 4.0 μm, and more preferably in the range of 1.0 μm to 3.0 μm.

The volume-average particle diameter D50v of toner particles with a particle diameter of 2 μm or more in a dry state is measured by the use of a measuring instrument such as Multisizer-II (made by Beckman Coulter Inc.). The volume-average particle diameter D50v of toner particles with a particle diameter of 2 μm or less or dispersed in carrier oil is measured by the use of a laser diffraction/scattering particle size distribution analyzer (such as LA920 (made by Horiba Ltd.)). In particle size ranges (channels) divided on the basis of the particle size distribution obtained through the measurement, a cumulative volume distribution is drawn from a small-diameter side and the particle diameter of which the cumulative value is 50% is defined as volume D50v.

When the toner is used as a developer to be described later, the resultant toner may be dispersed in a carrier liquid such as carrier oil and may be pulverized with a pulverizer such as a ball mill and an attritor to reduce the particle diameter of the toner to the lower limit of the volume-average particle diameter D50v of the toner particles.

### Developer

In this exemplary embodiment, the “developer” is used as a meaning including both a “liquid developer” containing the toner according to this exemplary embodiment and an insulating carrier liquid and a “dry developer” containing the toner according to this exemplary embodiment and a carrier including a magnetic metal or a magnetic oxide.

Particularly, the liquid developer of the developer according to this exemplary embodiment will be first described below. The toner is described above already and will not be described herein.

### Carrier Liquid

The carrier liquid is not particularly limited as long as it is a liquid in which toner particles may be dispersed, and examples thereof include non-aqueous solvents with a volume resistivity of 1.0×10¹⁰ Ω·cm or more. Among these, a non-aqueous solvent in which the binder resin is not soluble well (that is, in which toner particles are present as solid in the developer) may be suitably used.

The non-aqueous solvent means to include a solvent other than water, may be a mixture of water and a solvent other than water, or may be a solvent not actively including water. Examples of the non-aqueous solvent include aliphatic hydrocarbon solvents such as paraffin oil (commercially-available products such as MORESCO WHITE MT-302, MORESCO WHITE 240, MORESCO WHITE P70 made by Matsumura Oil Co., Ltd., and ISOPAR L and ISOPAR M made by Exxon Chemical Co.) hydrocarbon solvents such as naphthenic oil (commercially-available products such as EXXSOL D80, EXXSOL DUO, and EXXSOL D130 made by Exxon Chemical Co., and NAPHTESOL L, NAPHTESOL M, NAPHTESOL H, New NAPHTESOL 160, New NAPHTESOL 200, New NAPHTESOL 220, and New NAPHTESOL MS-202 made by JX Nippon Oil & Energy Corporation), silicone oil, and vegetable oil. An aromatic compound such as toluene may be added thereto. As the non-aqueous solvent, the components may be used singly or in combination of two or more. When two or more types of non-aqueous solvents are mixed and used, a mixture of paraffin oil and vegetable oil or a mixture of silicone oil and vegetable oil may be used.

The carrier liquid used in this exemplary embodiment preferably includes paraffin oil as a major component. Here, the “major component” means a component of the content is the greatest in the carrier liquid and is preferably greater than or equal to 50 vol %. The paraffin oil has high compatibility with the polyurethane thermoplastic elastomer (C) included in the toner particles and the scratch resistance (scratch characteristic) thereof is satisfactorily improved by using the carrier liquid including paraffin oil as a major component.

The carrier liquid may include various secondary materials such as a dispersant, an emulsifier, a surfactant, a stabilizer, a wetting agent, a thickener, a foaming agent, an antifoaming agent, a coagulant, a gelling agent, an anti-settling agent, a charge-controlling agent, an anti-static agent, an anti-oxidant, a softener, a plasticizer, a filler, a fragrance, an anti-tack agent, and a release agent.

### Characteristics of Carrier Liquid

The volume resistivity of the carrier liquid is, for example, in the range of 1.0×10¹⁰ Ω·cm to 1.0×10¹⁴ Ω·cm and preferably in the range of 1.0×10¹⁰ Ω·cm to 1.0×10¹³ Ω·cm.

### Method of Producing Developer

The developer according to this exemplary embodiment is obtained by mixing the toner particles and the carrier liquid by the use of a disperser such as a ball mill, a sand mill, an attritor, and a bead mill, pulverizing the resultant, and dispersing the toner particles in the carrier liquid. The unit of dispersing the toner particles in the carrier liquid is not limited to the disperser, but the dispersion may be performed by rotating a special stirring blade at a high speed like a mixer, by the use of a shearing force of a rotor and stator known as a homogenizer, and by the use of ultrasonic waves.

The concentration of the toner particles in the carrier liquid is preferably in the range of 0.5% by weight to 50% by weight and more preferably in the range of 1% by weight to 40% by weight, from the viewpoint of appropriately controlling viscosity of the developer to smooth the circulation of the developer in the developing device.

Thereafter, the resultant dispersion may be filtered, for example, with a membrane filter having an aperture diameter of 100 μm to remove waste and coarse particles.

The dry developer of the developer according to this exemplary embodiment will be described below. The toner is described above already and will not be described herein. The dry developer described below is a two-component developer including the toner according to this exemplary embodiment and the carrier including a magnetic metal or a magnetic oxide.

The carrier used in the two-component developer is not particularly limited and known carriers may be used. Examples thereof include magnetic metals such as iron oxide, nickel, and cobalt, magnetic oxides such as ferrite and magnetite, resin-coated carriers having a resin coating layer on the surface of the core thereof, and magnetic-dispersed carriers. Resin-dispersed carriers in which a conductive material or the like is dispersed in a matrix resin may be used.

Examples of the coating resin or the matrix resin used in the carrier include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymer, styrene-acrylate copolymer, straight silicone resin having an organosiloxane bond or modified products thereof, fluorine resin, polyester, polycarbonate, phenol resin, and epoxy resin, but the coating resin or the matrix resin is not limited to these examples.

Examples of the conductive material include metals such as gold, silver, and copper, carbon black, titanium oxide, zinc oxide, barium sulfate, aluminum borate, potassium titanate, and tin oxide, but the conductive material is not limited to these examples.

Examples of the core material of the carrier include magnetic metals such as iron, nickel, and cobalt, magnetic oxide such as ferrite and magnetite, and glass beads. In order to use the carrier in a magnetic brush method, the core material is preferably a magnetic material.

The volume-average particle diameter of the core material of the carrier is typically in the range of 10 μm to 500 μm and preferably in the range of 30μ to 100 μm.

When it is intended to coat the surface of the core material of the carrier with a resin, a method of coating the surface of the core material with a coating layer forming solution in which the coating resin and various additives if necessary are dissolved in an appropriate solvent may be used. The solvent is not particularly limited, and may be appropriately selected in consideration of the used coating resin and the coating aptitude.

Specific examples of the resin coating method include a dipping method of dipping the core material of the carrier in a coating layer forming solution, a spray method of spraying a coating layer forming solution to the surface of the core material of the carrier, a fluidized bed method of spraying a coating layer forming solution to the core material of the carrier in a state where the core material is floated with fluidized air, and a kneader and coater method of mixing the core material of the carrier and a coating layer forming solution in a kneader and coater to remove the solvent.

In the two-component developer, the mixing ratio (weight ratio) of the toner according to this exemplary embodiment and the carrier is preferably in the range of 1:100 to 30:100 in terms of toner:carrier and more preferably in the range of 3:100 to 20:100.

### Developer Cartridge

A developer cartridge according to this exemplary embodiment is a developer cartridge accommodating the liquid developer according to the exemplary embodiment or a developer cartridge accommodating a two-component developer which is the dry developer according to the exemplary embodiment. Here, in the developer cartridge accommodating any developer of the liquid developer and the dry developer, for example, the developer stored in the developer cartridge is supplied to a developing device of an image forming apparatus via a supply pipe. The developer cartridge may be detachably attached to the image forming apparatus for the purpose of replacement when the developer remaining in the developer cartridge is used up.

### Image Forming Apparatus

### Process Cartridge and Image Forming Apparatus

An image forming apparatus according to this exemplary embodiment includes a latent image holding member (hereinafter, also referred to as a “photoreceptor”), a latent image forming unit that forms a latent image on a surface of the latent image holding member, a developing unit that includes a developer holding member and that develops the latent image formed on the surface of the latent image holding member with the above-mentioned developer held on the surface of the developer holding member to form a toner image, a transfer unit that transfers the toner image formed on the surface of the latent image holding member to a recording medium, and a fixing unit that fixes the toner image transferred to the recording medium to the recording medium to form a fixed image. Here, the “developer” includes both a “liquid developer” including a toner and an insulating carrier liquid and a “dry developer” including a toner and a magnetic metal or a magnetic oxide.

First, an image forming apparatus using the developer according to this exemplary embodiment will be described below with reference to the accompanying drawings.

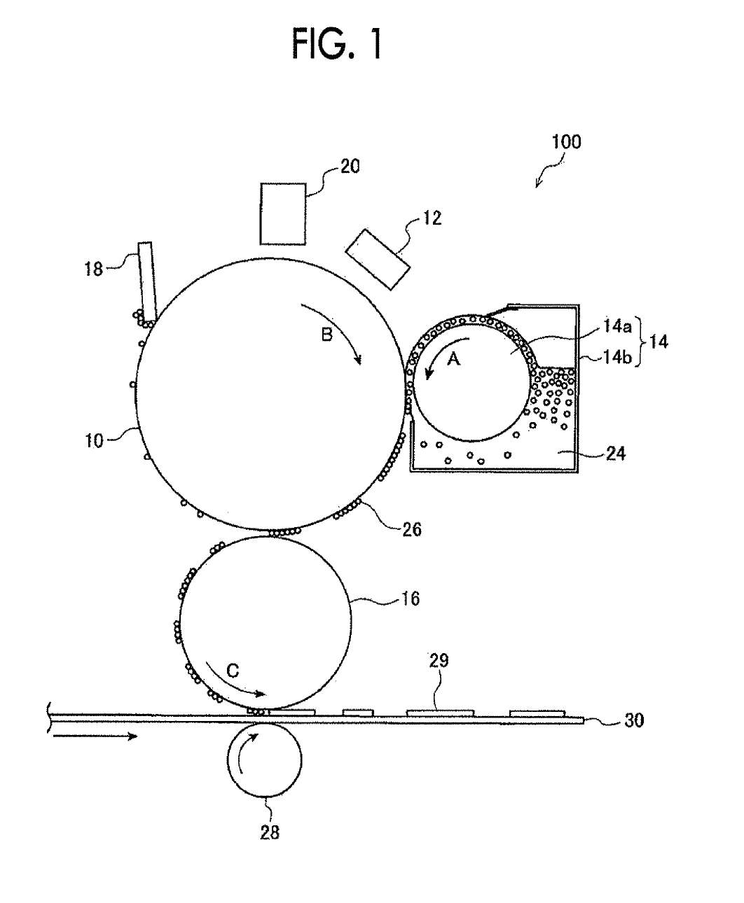

FIG. 1 is a schematic diagram illustrating an example of the configuration of the image forming apparatus according to this exemplary embodiment. The image forming apparatus 100 includes a photoreceptor (latent image holding member) 10, a charging device (charging unit) 20, an exposing device (latent image forming unit) 12, a developing device (developing unit) 14, an intermediate transfer member (transfer unit) 16, a cleaner 18, and a transfer and fixing roller (transfer unit) 28. The photoreceptor 10 has a cylindrical shape, and the charging device 20, the exposing device 12, the developing device 14, the intermediate transfer member 16, and the cleaner 18 are sequentially arranged around the photoreceptor 10.

The operation of the image forming apparatus 100 will be described below in brief.

The charging device 20 charges the surface of the photoreceptor 10 to a predetermined potential, and the exposing device 12 exposes the charged surface, for example, with a laser beam on the basis of an image signal to form an electrostatic latent image.

The developing device 14 includes a developing roller 14a and a developer container 14b. The developing roller 14a is disposed so that a part thereof is dipped in a developer 24 contained in the developer container 14b. The developer 24 includes an insulating carrier liquid and toner particles.

The toner particles are dispersed in the developer 24 but the positional concentration deviation of the toner particles in the developer 24 is reduced, for example, by continuously stirring the developer 24 through the use of a stirring member disposed in the developer container 14b. Accordingly, the developing roller 14a rotating in the direction of arrow A in the drawing is supplied with the developer 24 having the concentration deviation of the toner particles reduced.

The developer 24 supplied to the developing roller 14a is supplied to the photoreceptor 10 in a state where the amount to be supplied is limited to be constant by a regulation member, and is supplied to the electrostatic latent image at a position where the developing roller 14a is close to (or comes in contact with) the photoreceptor 10. Accordingly, the electrostatic latent image is developed to form a toner image 26.

The developed toner image 26 is transported by the photoreceptor 10 rotating in the direction of arrow B in the drawing and is then transferred to a sheet of paper (recording medium) 30. However, in this exemplary embodiment, the toner image is temporarily transferred to the intermediate transfer member 16 so as to improve the transfer efficiency to the recording medium including the peeling efficiency of the toner image from the photoreceptor 10 and to fix the toner image at the same time as transferring the toner image to the recording medium before it is transferred to the sheet of paper 30. At this time, a difference in circumferential speed may be formed between the photoreceptor 10 and the intermediate transfer member 16.

Subsequently, the toner image transported in the direction of arrow C by the intermediate transfer member 16 is transferred and fixed to the sheet of paper 30 at the contact position with the transfer and fixing roller 28.

The transfer and fixing roller 28 nips the sheet of paper 30 along with the intermediate transfer member 16 and brings the toner image on the intermediate transfer member 16 into close contact with the sheet of paper 30. Accordingly, the toner image is transferred to the sheet of paper 30 and the toner image is fixed to the sheet of paper to form a fixed image 29. The fixation of the toner image is preferably performed by providing a heater to the transfer and fixing roller 28 and pressurizing and heating the toner image. The fixing temperature is generally in the range of 120° C. to 200° C.

When the intermediate transfer member 16 has a roller shape as shown in FIG. 1, the intermediate transfer member 16 and the transfer and fixing roller 28 constitute a pair of rollers and thus the intermediate transfer member 16 and the transfer and fixing roller 28 have the configuration similar to a fixing roller and a backup roller respectively in a fixing device to exhibit a fixing function. That is, when the sheet of paper 30 passes through the nip, the toner image is transferred to the sheet of paper and the sheet of paper is heated and pressurized against the intermediate transfer member 16 by the transfer and fixing roller 28. Accordingly, the binder resin of the toner particles constituting the toner image is softened and the toner image is infiltrated into fibers of the sheet of paper 30, whereby the fixed image 29 is formed on the sheet of paper 30.

In this exemplary embodiment, the fixation is performed at the same time as the transfer to the sheet of paper 30, but the transfer process and the fixing process may be separated so as to perform the fixation after performing the transfer. In this case, the transfer roller transferring the toner image from the photoreceptor 10 has the function of the intermediate transfer member 16.

On the other hand, in the photoreceptor 10 having transferred the toner image 26 to the intermediate transfer member 16, the toner particles remaining after the transfer are shifted to the contact position with the cleaner 18 and are collected by the cleaner 18. When the transfer efficiency is close to 100% and the remaining toner does not cause any problem, it is not necessary to provide the cleaner 18.

The image forming apparatus 100 may include an erasing device (not shown) erasing the surface of the photoreceptor 10 after the transfer and until the next charging.

The charging device 20, the exposing device 12, the developing device 14, the intermediate transfer member 16, the transfer and fixing roller 28, and the cleaner 18 included in the image forming apparatus 100 operate in synchronization with the rotation speed of the photoreceptor 10.

By forming an image of a recording medium 30 such as a sheet of paper by the use of the image forming apparatus 100 having the above-mentioned configuration, it is possible to obtain an image with high bending resistance.

Another image forming apparatus using the two-component developer according to this exemplary embodiment will be described below.

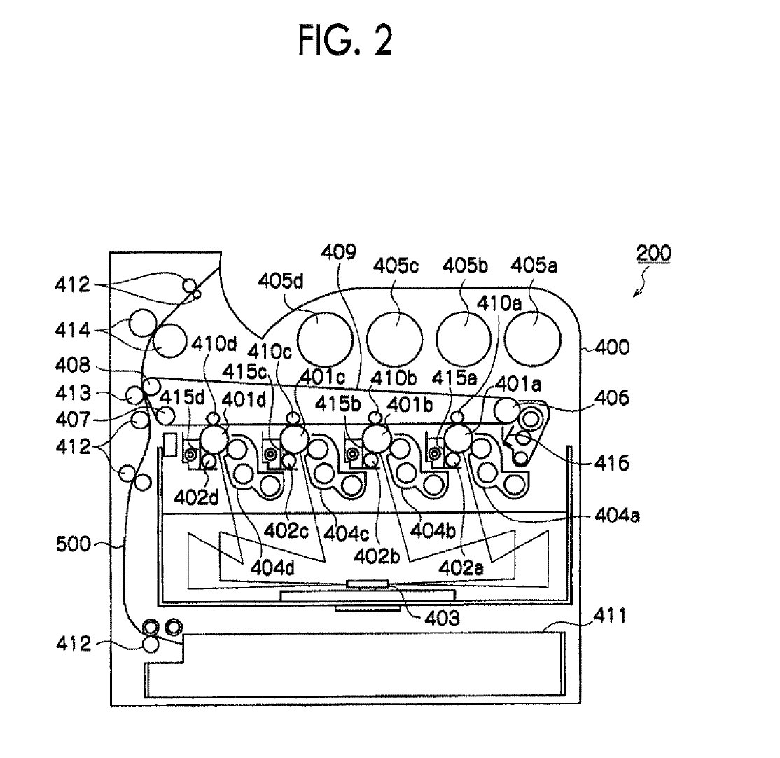

FIG. 2 is a schematic diagram illustrating another example of the configuration of the image forming apparatus forming an image through the use of an image forming method according to this exemplary embodiment. In the image forming apparatus 200 shown in the drawing, four electrophotographic photoreceptors 401a to 401d are arranged in parallel along an intermediate transfer belt 409 in a housing 400. Regarding the electrophotographic photoreceptors 401a to 401d, for example, a yellow image is formed by the photoelectric photoreceptor 401a, a magenta image is formed by the photoelectric photoreceptor 401b, a cyan image is formed by the photoelectric photoreceptor 401c, and a black image is formed by the photoelectric photoreceptor 401d.

Each of the electrophotographic photoreceptors 401a to 401d can rotate in a predetermined direction (in the counterclockwise direction in the drawing), and charging rollers 402a to 402d, developing devices 404a to 404d, primary transfer rollers 410a to 410d, and cleaning blades 415a to 415d are arranged in the rotation direction. The developing devices 404a to 404d are supplied with four color toners of black, yellow, magenta, and cyan contained in developer cartridges 405a to 405d, respectively, and the primary transfer rollers 410a to 410d come in contact with the photoelectric photoreceptors 401a to 401d with the intermediate transfer belt 409 interposed therebetween, respectively.

An exposing device 403 is disposed at a predetermined position in the housing 400. The surfaces of the charged electrophotographic photoreceptors 401a to 401d are irradiated with a light beam emitted from the exposing device 403. Accordingly, in the process of rotation of the electrophotographic photoreceptors 401a to 401d, charging, exposing, developing, primary transfer, and cleaning steps are sequentially performed and the color toner images are transferred to the intermediate transfer belt 409 in an overlapping manner.

Here, the charging rollers 402a to 402d bring conductive members (charging rollers) into contact with the surfaces of the electrophotographic photoreceptors 401a to 401d and uniformly apply a voltage to the photoreceptors to charge the surfaces of the photoreceptors to a predetermined potential (charging step). The charging step may be performed in a contact charging manner using a charging brush, a charging film, or a charging tube other than the charging roller used in this exemplary embodiment. Alternatively, the charging step may be performed in a non-contact manner using a corotron or a scorotron.

An optical system device such as a semiconductor laser, an LED (Light Emitting Diode), or a liquid crystal shutter forming a desired image on the surface of the electrophotographic photoreceptors 401a to 401d is used as the exposing device 403. Among these, when an exposing device emitting incoherent light is used, an interference pattern between the conductive member of the electrophotographic photoreceptors 401a to 401d and the photoreceptor layers is prevented.

A typical developing device developing an image in a contact manner or a non-contact manner with the two-component electrostatic latent image developer is used as the developing devices 404a to 404d (developing step). The developing device is not particularly limited as long as it uses the two-component electrostatic charge image developing developer, and a known developing device may be appropriately selected depending on the purpose thereof. In the primary transfer step, by applying a primary transfer bias with the opposite polarity to that of the toner held by an image holding member to the primary transfer rollers 410a to 410d, the color toners are sequentially primarily transferred from the image holding member to the intermediate transfer belt 409.

The cleaning blades 415a to 415d serve to remove the remaining toner attached to the surface of the electrophotographic photoreceptors after the transfer step, and the electrophotographic photoreceptors cleaned thereby are repeatedly provided to the image forming process. Examples of the material of the cleaning blade include a urethane rubber, a neoprene rubber, and a silicone rubber.

The intermediate transfer belt 409 is supported by a driving roller 406, a backup roller 408, and a tension roller 407 with a predetermined tension and can rotate without any crease with the rotation of the rollers. The secondary transfer roller 413 is disposed to come in contact with the backup roller 408 with the intermediate transfer belt 409 interposed therebetween.

By applying a secondary transfer bias with the opposite polarity to that of the toner on the intermediate transfer member to the secondary transfer roller 413, the toner image is secondarily transferred from the intermediate transfer belt to a recording medium. The intermediate transfer belt 409 passing between the backup roller 408 and the secondary transfer roller 413 is cleaned, for example, by the cleaning blade 416 or the erasing device (not shown) disposed around the driving roller 406, and is then repeatedly provided to the next image forming processes. A tray (transfer medium tray) 411 is disposed at a predetermined position in the housing 400. A transfer medium 500 such as a sheet of paper in the tray 411 is sequentially transported between the intermediate transfer belt 409 and the secondary transfer roller 413 and between two fixing rollers 414 contacting with each other and is then discharged to the outside of the housing 400 by a transport roller 412.

### Image Forming Method

The image forming method according to this exemplary embodiment includes at least a step of forming a latent image on a surface of a latent image holding member, a step of developing the latent image formed on the surface of the latent image holding member with the above-mentioned developer (a liquid developer or a dry developer including the two-component developer) held on the surface of a developer holding member to form a toner image, a step of transferring the toner image formed on the surface of the latent image holding member to a recording medium, and a step of fixing the toner image transferred to the recording medium to the recording medium to form a fixed image.

The steps employ known steps in the image forming methods.

Examples of the latent image holding member include an electrophotographic photoreceptor and a dielectric recording member. In case of the electrophotographic photoreceptor, the surface of the electrophotographic photoreceptor is uniformly charged by the use of a corotron charger or a contact charger and is then exposed to light to form an electrostatic latent image (latent image forming step). Subsequently, the electrophotographic photoreceptor comes in contact with or gets close to the developing roller having a developer layer formed on the surface thereof and toner particles are attached to the electrostatic latent image to form a toner image on the electrophotographic photoreceptor (developing step). The formed toner image is transferred to the surface of a transfer medium such as a sheet of paper by the use of a corotron charger or the like (transfer step). If necessary, the toner image transferred to the surface of the transfer medium is thermally fixed by the use of a fixing device to form a final toner image.

When performing the thermal fixing step by the use of the fixing device, a release agent is supplied to a fixing member of a typical fixing device so as to prevent an offset or the like, but it is not necessary to supply a release agent to the fixing device of the image forming apparatus according to this exemplary embodiment and the fixing step is performed in an oilless manner.

The method of supplying a release agent to the surface of a roller or a belt which is a fixing member used for the thermal fixing step is not particularly limited and examples thereof include a pad method using a pad impregnated with a liquid release agent, a web method, a roller method, and a non-contact shower method (spray method). Among these, the web method or the roller method may be preferably used. It is advantageous to use these methods, in that the release agent may be uniformly supplied and the amount of release agent to be supplied may be easily controlled. When it is intended to uniformly supply the release agent to the overall surface of the fixing member by the use of the shower method, it is necessary to use a particularly blade or the like.

Examples of the transfer medium (recording material) to which the toner image is transferred include a sheet of regular paper and an OHP sheet used in a copying machine or a printer of an electrophotographic type.

### EXAMPLES

The invention will be described below with reference to examples, but the invention is not limited to the examples. As long as not differently mentioned in the examples, “part” means “part by weight” and “%” means “% by weight”.

### Methods of Measuring Various Characteristics

First, characteristics measuring methods of toners used in examples and comparative examples will be described below.

Method of Measuring Toner Particle Size and Particle Size Distribution

The toner particle size and the particle size distribution in the invention are measured using Multisizer II (made by Beckman Coulter Inc.) as a measuring instrument and using ISOTRON-II (made by Beckman Coulter Inc.) as an electrolytic solution.

In the measuring method, 0.5 to 50 mg of a measurement sample is added to a surfactant, preferably, 2 ml of a 5% aqueous solution of sodium alkylbenzene sulfonate, as a dispersant. The resultant is added to 100 to 150 ml of the electrolytic solution. The electrolytic solution in which the sample is suspended is dispersed by the use of an ultrasonic disperser for about 1 minute, the particle size distribution of 2 to 60 μm particles is measured with 100 μm aperture as an aperture diameter by the use of Multisizer II, and the volume-average particle diameter is calculated. The number of particles to be measured is 50,000.

The particle size distribution of the toner particles is calculated through the following method. Cumulative volume distributions are drawn from the smallest particle size in particle size ranges (channels) into which the measured particle size distribution is divided, the cumulative volume particle diameter at which the accumulated value is 16% is defined as 016v, the cumulative volume particle diameter at which the accumulated value is 50% is defined as D50v. The cumulative volume particle diameter at which the accumulated value is 84% is defined as D84v.

The volume-average particle diameter in the invention is D50v and the volume-average particle size distribution index GSDv is calculated by the following expression.

Expression: GSDv=(D84v/D16v)^{0.5}

When the toner to be measured is dispersed in carrier oil, the particle diameter is measured by the use of a laser diffraction/scattering particle size distribution analyzer (such as LA920 made by Horiba Ltd.) In measurement, a sample in a dispersion state is adjusted to be about 2 g in solid content and the carrier oil is added thereto to reach about 40 ml. The resultant is input to a cell up to an appropriate concentration, and the particle diameter is measured when the concentration in the cell is stabilized after about 2 minutes. The particle diameter for each channel is accumulated from the smallest particle diameter and the particle diameter when the cumulative value is 50% is defined as the volume-average particle diameter.

When the particle diameter of a powder such as an external additive is measured, 2 g of the measurement sample is added to 50 ml of a 5% aqueous solution of a surfactant, preferably, sodium alkylbenzene sulfonate, the resultant is dispersed with an ultrasonic disperser (1,000 Hz) for 2 minutes to prepare a sample, and the volume-average particle diameter is measured in the same way as in the above-mentioned dispersion.

### Weight-Average Molecular Weight of Resin and Measurement of Molecular Weight Distribution

In the invention, the molecular weight of the binder resin or the like is measured under the following conditions. “HLC-8120 GPC and SC-8020 made by Tosoh Corporation” are used as a GPC instrument, two “TSKgel Super HM-H (6.0 mmID×15 cm)” are used as a column, and tetrahydrofuran (THF) is used as an eluant. The test conditions include a sample concentration of 0.5%, a flow rate of 0.6 ml/min, an amount of sample introduced of 10 μl, and a measuring temperature of 40° C., and the test is performed using an IR detector. A calibration curve is prepared from ten samples of “A-500”, “F-1”, “F-10”, “F-80”, “F-380”, “A-2500”, “F-4”, “F-40”, “F-128”, and “F-700” which are “polystyrene standard samples TSK standard” made by Tosoh Corporation.

### Measurement of Glass Transition Temperature, Melting Point, and Endothermic Peak Temperature of Resin

The endothermic peak temperature of the crystalline polyester resin and the glass transition temperature (Tg) of the amorphous polyester resin are measured using a differential scanning calorimeter (DSC-60A, made by Shimadzu Corporation) on the basis of the ASTM D3418. The melting points of indium and zinc are used to correct the temperature of a detection unit of the instrument (DSC-60A) and the melting heat of indium is used to correct the quantity of heat. The sample is input to an aluminum pan and an empty aluminum pan for comparison is set. The temperature is raised at a temperature-rising rate of 10° C./min, the resultant is held at 200° C. for 5 minutes, the temperature is lowered at −10° C./min from 200° C. to 0° C. using liquid nitrogen, the resultant is held at 0° C. for 5 minutes, and then the temperature is raised again at 10° C./min from 0° C. to 200° C. The endothermic curve at the second rise in temperature is analyzed, the onset temperature of the amorphous polyester resin is defined as Tg, and the endothermic peak temperature of the maximum peak in the crystalline polyester resin is defined as the melting point Tm.

### Measurement of Acid Value

The acid value is measured on the basis of the JIS K2501.

### Introduction of Acid Value of Crystalline Polyester Resin (B)

50 parts by weight of a polyester polyol resin (ODX-2555 made by DIC Corporation, with a weight-average molecular weight of 15,000, an OH value of 30 mg KOH/g, and an acid value of less than 0.2 mg KOH/g), 6.0 parts by weight of phthalic anhydride (made by Wako Pure Chemical Industries, Ltd.), 0.2 part by weight of pyridine (made by Wako Pure Chemical Industries, Ltd.), and 65 parts by weight of toluene are input to a flask having stirrer and a cooling pipe installed therein and are stirred at a toluene reflux temperature (about 110° C.) for 3 hours to react with each other. After cooling the resultant, the reactant solution is dropped in 800 parts by weight of acetone and a resin is extracted. The extracted resin is filtered and is then dried in vacuum at 40° C., whereby Crystalline Polyester Resin (B1) according to the invention is obtained. The measured acid value is 28 mg KOH/g.

### Preparation of Charge-Controlling Agent

24.0 g of 1-octadecene, 46 parts by weight of N-phenylmaleimide, 62 parts by weight of maleic anhydride, and 0.62 part by weight of benzoyl peroxide are dissolved in 450 parts by weight of methylethyl ketone, the atmosphere is substituted with nitrogen, and the resultant is continuously slowly stirred at a reflux temperature of 83° C. to 84° C. for 15 hours. After naturally cooling the resultant, the mixture is slowly input to 2-propanol (12,000 parts by weight) while stirring the resultant and the extracted precipitate is filtered, is washed with 2-propanol, and is then depressurized and dried, whereby 49 parts by weight of light-yellow powder is obtained. 41 parts by weight of the light-yellow powder, 19 parts by weight of hexadecylamine, and 0.44 part by weight of pyridine are dissolved in 400 parts by weight of toluene and the resultant is continuously stirred at a toluene reflux temperature (115° C.) for 3 hours. After the end of the reaction, the mixture is input to methanol (800 mL) and the extracted precipitate is filtered, is washed with methanol, and is then depressurized and dried, whereby 52 parts by weight of Charge-controlling Agent A is obtained. The molecular weight of Charge-controlling Agent A measured through the use of the GPC (gel permeation chromatography) is 7,400 (in terms of polystyrene) in weight-average molecular weight.

### Preparation of Amorphous Polyester Resin (A1)

Source monomers other than trimellitic anhydride shown in Table 1, 40 g of tin (II) 2-ethylhexane (esterification catalyst), and 4 g of tertiary butylcatechol (polymerization inhibitor) are input to a 10 L four-neck flask having a nitrogen introduction pipe, a dewatering pipe, stirrer, and a thermocouple installed therein, and the resultant is made to react at 210° C. for 8 hours and is then made to react at 8.3 kPa for 1 hour. Trimellitic anhydride is added thereto at 210° C. and is made to react until a desired softening point is reached, whereby Amorphous Polyester Resin (A1) is obtained.

TABLE 1

| Source monomer | Amorphous polyester |
|---|---|
| BPA-PO¹⁾ | 5005 g(70) |
| BPA-EO²⁾ | 2046 g(30) |
| Fumalic acid | 1531 g(60) |
| Adipic acid | 317 g(10) |
| Trimellitic anhydride | 634 g(15) |

Note)
The numerical values in parentheses represent mole ratios with respect to total 100 moles of alcohol components.
¹⁾polyoxypropylene (2.1)-2,2-bis(4-hydroxyphenyl)propane
²⁾polyoxyethylene (2.1)-2,2-bis(4-hydroxyphenyl)propane

### Preparation of Amorphous Polyester Resin (A2)

Bisphenol A propylene oxide aduct (NEWPOL BP-2P, made by Sanyo Chemical Industries Ltd.): 100 mol %
Terephthalic acid: 70 mol %
Dodecenylsuccinate: 22 mol %
Trimellitic anhydride: 3 mol %

Monomers other than the trimellitic anhydride out of the monomers and tin dioctanate are input in 0.17 part by weight with respect to 100 parts by weight of the monomer components to a flask having a stirrer, a thermometer, a condenser, and a nitrogen gas introduction pipe, the resultant is made to react under a nitrogen gas flow at 235° C. for 6 hours, the temperature is lowered to 190° C., trimellitic anhydride is input thereto, and the resultant is made to react for 1 hour. The temperature is raised to 220° C. for 4 hours and the resultant is polymerized until reaching a desired molecular weight under a pressure of 10 kPa, whereby light-yellow transparent Amorphous Polyester Resin (A2) is obtained.

### Example 1

### Preparation of Developer 1

### Using Kneading and Pulverizing Method

40 parts by weight of a cyan pigment C.I. Pigment Blue 15:3 (made by Clariant International Ltd.) is added to 60 parts by weight of an amorphous polyester resin (TP-235, made by Nippon Synthetic Chemical Industry Co., Ltd., with a weight-average molecular weight of 16,000 and Tg=65° C.) and the resultant is kneaded with a pressurizing kneader. The kneaded resultant is coarsely pulverized to prepare a cyan pigment master batch.

The mixture of the following compositions is kneaded with a Banbury mixer.
Cyan pigment master batch: 25 parts by weight
Amorphous polyester resin (TP-235, made by Nippon Synthetic Chemical Industry Co., Ltd., with a weight-average molecular weight of 16,000 and Tg=65° C.): 50 parts by weight
Polyurethane thermoplastic elastomer (PANDEX T-5210, made by DIC Corporation): 15 parts by weight
Crystalline polyester resin (SP-170, made by Nippon Synthetic Chemical. Industry Co., Ltd., with a weight-average molecular weight of 19,000 and a melting point of 83° C.): 10 parts by weight

The kneaded material is rolled and cooled, is coarsely pulverized, and is finely pulverized with a jet mill, and is then classified with wind power, whereby Dry Toner Particle 1 with a volume-average particle diameter of 5.8 μm is obtained.

### Preparation of Developer 11

### Preparation of Carrier

Ferrite particles (with a volume-average particle diameter of 35 μm): 100 parts
Toluene: 14 parts
Methylmethacrylate-perfluoroacrylate copolymer (8:2, Mw=66,000, with a threshold surface tension of 24 dyn/cm): 1.6 parts
Carbon black (product name: VXC-72, made by Cabot Corporation, with resistance of 100 Ωcm or less): 0.12 part
Cross-linked melamine resin particles (with a volume-average particle diameter of 0.3 μm, insoluble in toluene): 0.3 part

The materials other than the ferrite particles are dispersed with a stirrer for 10 minutes to form a coating layer forming solution.

The coating layer forming solution and the ferrite particles are input to a vacuum deaeration kneader, the resultant is stirred at a temperature of 60° C. for 30 minutes, and the kneader is depressurized to distil away toluene and to form a resin coating layer, whereby a carrier is obtained (here, a material obtained by diluting carbon black with toluene and dispersing the resultant in the perfoluroracrylate copolymer which is a carrier resin with a sand mill).

8 parts by weight of Toner 1 and 100 parts by weight of the carrier are mixed to prepare a two-component developer, whereby Developer 11 is obtained.

### Preparation of Developer 12

Subsequently, 85 parts by weight of paraffin oil (MORESCO WHITE MT30P made by Matsumura Oil Co., Ltd.) and 0.1 part by weight of Charge-controlling Agent A are mixed with 15 parts by weight of Dry Toner 1 and the mixture is further finely pulverized with a ball mill, whereby Developer 12 in which toner particles with a volume-average particle diameter of 2.6 are dispersed is obtained.

### Example 2

### Preparation of Developer 2

### Using Precipitation Method

40 parts by weight of a yellow pigment C. I. Pigment Yellow 185 (made by BASF Corporation) is added to 60 parts by weight of an amorphous polyester resin (Amorphous Polyester Resin (A1) with a weight-average molecular weight of 18,000 and Tg=61° C.) and the resultant is kneaded with a pressurizing kneader. The kneaded material is coarsely pulverized to prepare a yellow pigment master batch.

The mixture of the following compositions is dissolved and dispersed with a ball mill for 24 hours.
Yellow pigment master batch thus obtained: 25 parts by weight
Amorphous polyester resin (Amorphous Polyester Resin (A1) with a weight-average molecular weight of 18,000): 47 parts by weight
Polyurethane thermoplastic elastomer (RESAMINE NE310, made by Dainichiseika Color & Chemicals Mfg. Co., Ltd., with a solid content concentration of 25%): 80 parts by weight
Crystalline polyester resin (ODX-2523, made by DIC Corporation, with a weight-average molecular weight of 15,000): 8 parts by weight
THF: 900 parts by weight

Subsequently, 200 parts by weight of methanol is input to a 5 L flask having a stirrer (ULTRA-TURRAX T-25, made by IKA Co., Ltd.) installed therein, the temperature is raised to 40° C., and the resultant is stirred at 8,000 rpm. 100 parts by weight of the mixture of which the temperature is raised to 40° C. is dropped thereon, whereby an extract is obtained. After cooling the extract, the obtained extract is filtered and is dried in vacuum at 40° C., whereby a toner base material is obtained. The toner base material is finely pulverized with a jet mill and is then classified with wind power, whereby Dry Toner Particle 2 with a volume-average particle diameter of 5.8 μm is obtained.

### Preparation of Developer 21

8 parts by weight of Toner 2 thus obtained and 100 parts by weight of the carrier used in Developer 11 are mixed to prepare a two-component developer, whereby Developer 21 is obtained.

Preparation of Developer 22

A mixture of 15 parts by weight of Toner 2, 85 parts by weight of paraffin oil (ISOPAR L made by Exxon Chemical Co.), and 0.1 part by weight of Charge-controlling Agent A is finely pulverized with a ball mill, whereby Developer 22 in which toner particles with a volume-average particle diameter of 2.5 are dispersed is obtained.

### Example 3

### Preparation of Developer 3

### Using Chemical Method

20 parts by weight of a magenta pigment, C.I. Pigment Red 122 (made by Clariant Corporation) and 20 parts by weight of C.I. Pigment Red 57:1 (made by Dainichiseika Color & Chemicals Mfg. Co., Ltd.) are added to 60 parts by weight of an amorphous polyester resin (Amorphous Polyester Resin (A2) with a weight-average molecular weight of 53,000 and an acid value of 14 mg KOH/g) and the resultant is kneaded with a pressurizing kneader. The kneaded material is coarsely pulverized to prepare a magenta pigment master batch.

The mixture of the following compositions is input to a closed reaction vessel having a dissolver installed therein and is dissolved and dispersed at 45° C. for 5 hours.
Magenta pigment master batch thus obtained: 25 parts by weight
Amorphous polyester resin (Amorphous Polyester Resin (A2) with a weight-average molecular weight of 53,000 and an acid value of 14 mg/KOH/g): 8 parts by weight
Polyurethane thermoplastic elastomer (PANDEX T-5210, made by DIC Corporation): 49 parts by weight
Crystalline polyester resin (Crystalline Polyester Resin (B1), with a weight-average molecular weight of 15,000 and an acid value of 28 mg KOH/g): 18 parts by weight
Methylethyl ketone: 100 parts by weight

Subsequently, 26 parts of 1.5% aqueous ammonia is slowly added thereto and the resultant is stirred at 4,000 rpm while maintaining 40° C. 200 parts by weight of ion exchange water heated to 40° C. is slowly dropped thereto to perform phase-inverted emulsification. Then, 0.25 part by weight of a surfactant (PELEX CS, made by Kao Corporation) is added thereto, the stirring revolution rate is lowered to 500 rpm, and 38 parts by weight of a 5% sodium sulfate aqueous solution is slowly dropped thereto to aggregate the resultant. 200 parts by weight of ion exchange water is added thereto to stabilize the particles. The reaction vessel is depressurized with a vacuum pump while maintaining the raised temperature to remove methylethyle ketone. After cooling the reactant solution, particles are separated through centrifugal separation and are dried in vacuum at 40° C., whereby Dry Toner Particle 3 with a volume-average particle diameter of 4.6 μm is obtained.

### Preparation of Developer 31

8 parts by weight of Toner 3 and 100 parts by weight of the carrier used in Developer 11 are mixed to prepare a two-component developer, whereby Developer 31 is obtained.

### Preparation of Developer 32

A mixture of 15 parts by weight of Toner 3 thus obtained, 85 parts by weight of paraffin oil (ISOPAR L made by Exxon Chemical Co.), and 0.1 part by weight of Charge-controlling Agent A is finely pulverized with a ball mill, whereby Developer 32 in which toner particles with a volume-average particle diameter of 3.5 μm are dispersed is obtained.

### Comparative Example 1

Dry Toner 101 with a volume-average particle diameter of 5.8 μm is obtained in the same way as in Example 1, except that 15 parts by weight of the polyurethane thermoplastic elastomer (PANDEX T-5210, made by DIC Corporation) in Example 1 is replaced with 15 parts by weight of an amorphous polyester resin (TP-235, made by Nippon Synthetic Chemical Industry Co. Ltd.).

### Preparation of Developer 101

8 parts by weight of Dry Toner 101 thus obtained and 100 parts by weight of the carrier used in Developer 11 are mixed to prepare a two-component developer, whereby Developer 101 is obtained.

### Preparation of Developer 102

85 parts by weight of paraffin oil (MORESCO WHITE MT30P, made by Matsumura Oil Co., Ltd.) and 0.1 part by weight of Charge-controlling Agent A are mixed with 15 parts by weight of Dry Toner 101 thus obtained and the mixture is further finely pulverized with a ball mill, whereby Developer 102 in which toner particles with a volume-average particle diameter of 2.4 μm are dispersed is obtained.

### Comparative Example 2

Dry Toner 201 with a volume-average particle diameter of 5.6 μm is obtained in the same way as in Example 1, except that 10 parts by weight of the crystalline polyester resin (SP-170, made by Nippon Synthetic Chemical Industry Co., Ltd.) in Example 1 is replaced with 10 parts by weight of an amorphous polyester resin (TP-235, made by Nippon Synthetic Chemical Industry Co., Ltd.).

### Preparation of Developer 201

8 parts by weight of Dry Toner 201 thus obtained and 100 parts by weight of the carrier used in Developer 11 are mixed to prepare a two-component developer, whereby Developer 201 is obtained.

### Preparation of Developer 202

85 parts by weight of paraffin oil (MORESCO WHITE MT30P, made by Matsumura Oil Co., Ltd.) and 0.1 part by weight of Charge-controlling Agent A are mixed with 15 parts by weight of Dry Toner 201 thus obtained and the mixture is further finely pulverized with a ball mill, whereby Developer 202 in which toner particles with a volume-average particle diameter of 2.5 μm are dispersed is obtained.

### Comparative Example 3

Dry Toner 301 with a volume-average particle diameter of 5.8 μm is obtained in the same way as in Example 1, except that the amorphous polyester resin (TP-235, made by Nippon Synthetic Chemical Industry Co., Ltd.) in Example 1 is replaced with a polyurethane thermoplastic elastomer (PANDEX T-5210, made by DIC Corporation).

### Preparation of Developer 301

8 parts by weight of Dry Toner 301 thus obtained and 100 parts by weight of the carrier used in Developer 11 are mixed to prepare a two-component developer, whereby Developer 301 is obtained.

### Preparation of Developer 302

85 parts by weight of paraffin oil (MORESCO WHITE MT30P, made by Matsumura Oil Co., Ltd.) and 0.1 part by weight of Charge-controlling Agent A are mixed with 15 parts by weight of Dry Toner 301 thus obtained and the mixture is further finely pulverized with a ball mill, whereby Developer 302 in which toner particles with a volume-average particle diameter of 2.8 μm are dispersed is obtained.

### Comparative Example 4

Dry Toner 401 with a volume-average particle diameter of 5.8 μm is obtained in the same way as in Example 1, except that 15 parts by weight of the polyurethane thermoplastic elastomer (PANDEX T-5210, made by DIC Corporation) in Example is replaced with 15 parts by weight of a polyester thermoplastic elastomer (HYTREL 4057N, made by Du Pont-Toray Co., Ltd.).

### Preparation of Developer 401

8 parts by weight of Dry Toner 401 thus obtained and 100 parts by weight of the carrier used in Developer 11 are mixed to prepare a two-component developer, whereby Developer 401 is obtained.

### Preparation of Developer 402

85 parts by weight of paraffin oil (MORESCO WHITE MT30P, made by Matsumura Oil Co., Ltd.) and 0.1 part by weight of Charge-controlling Agent A are mixed with 15 parts by weight of Dry Toner 401 thus obtained and the mixture is further finely pulverized with a ball mill, whereby Developer 402 in which toner particles with a volume-average particle diameter of 4.8 μm are dispersed is obtained.

### Evaluation

Low-Temperature Fixability (MFT Evaluation) when Developer is Used

Regarding the developers prepared in the examples and the comparative examples, an image is formed on a sheet of color paper (J paper) made by Fuji Xerox Co., Ltd. with an amount. of toner loaded of 13.5 g/m² by the use of a modified machine of DocuCentreColor400 made by Fuji Xerox Co., Ltd. and shown in FIG. 2. After forming the image, a fixing process is performed at a fixing speed of 180 mm/sec with a nip of 6.5 mm by the use of an external fixing device. In order to evaluate the minimum fixing temperature in the fixability evaluation, the fixing device is modified so that the fixing temperature thereof is variable, and an image is fixed while raising the fixing temperature of the fixing roll at intervals of +5° C. from 90° C. An inward fold is formed almost at the center of a solid part of the fixed toner image on the sheet of paper having an image formed thereon, the part in which the fixed toner image is destroyed is wiped out with a tissue, a decolored line width is measured, and the temperature at which the decolored line width is equal to or less than 0.5 mm is defined as the minimum fixing temperature (MFT).

### Low-temperature Fixability (MFT Evaluation) When Developer is Used

The developers prepared in the examples and the comparative examples are diluted with the same oil (MORESCO WHITE 2-70) to be 2.5% and are input to a disposable cell (polystyrene). Two transparent electrodes disposed to face each other with a gap of 1 mm are immersed therein and a voltage of 300 V is applied thereto for 30 seconds. The electrodes are pulled out and the toner deposited on the plus electrode is transferred to a sheet of J coated paper made by Fuji Xerox Co., Ltd. The amount of toner deposited is measured as 4 g/m². The transferred image is fixed at a fixing speed of 500 mm/sec with a nip of 6 mm by the use of an external fixing device. In order to evaluate the minimum fixing temperature in the fixability evaluation, the fixing device is modified so that the fixing temperature thereof is variable, and an image is fixed while raising the fixing temperature of the fixing roll at intervals of +5° C. from 100° C. 60° gloss is measured with Micro-TRI-Gloss made by BYK-Gardner GMBH and the fixing temperature at which the image gloss is greater than 20 is defined as the minimum fixing temperature (MET). The results are shown in Table 2. In this evaluation, the MET lower than 130° C. is evaluated as being good.

### Bending Resistance

The bending resistance is evaluated from a destroyed state of an image after a sheet of paper is bent with a load of 2 kg/cm² with the image directed to the inside and the bent part is lightly wiped out. The evaluation criterion is as follows and the evaluation results are shown in Table 2.

A: Detachment of an image is hardly observed.

B: Slight and discontinuous detachment of an image is observed.

C: Discontinuous destruction is observed.

D: Continuous destruction is observed. Scratch Resistance

The scratch resistance is evaluated with a pressure of 0.5 kg by the use of a scratching tester made by Linax Co., Ltd.

The evaluation criterion is as follows and the evaluation results are shown in Table 2.

A: A decrease in concentration is hardly caused.

B: A decrease in concentration is present but an image remains.

C: A part of an image is detached.

TABLE 2

| | | Binder resin (% by weight) | | | | | |
|---|---|---|---|---|---|---|---|
| | | Amorphous | Crystalline | Thermoplastic | Evaluation result | | |
| | | polyester | polyester | elastomer | | Bending | Scratch |
| | developer | resin (A) | resin (B) | (C) | MFT (° C.) | resistance | resistance |
| Ex. 1 | 11 | 72 | 11 | 17 | 120 | A | A |
| | 12 | 72 | 11 | 17 | 120 | B | A |
| Ex. 2 | 21 | 58 | 20 | 22 | 115 | A | A |
| | 22 | 58 | 20 | 22 | 115 | A | A |
| Ex. 3 | 31 | 26 | 20 | 54 | 130 | A | B |
| | 32 | 26 | 20 | 54 | 130 | A | B |
| Ex. Com. 1 | 101 | 89 | 11 | 0 | 120 | D | B |
| | 102 | 89 | 11 | 0 | 120 | D | B |
| Ex. Com. 2 | 201 | 83 | 0 | 17 | 140 | B | B |
| | 202 | 83 | 0 | 17 | 150 | B | B |
| Ex. Com. 3 | 301 | 0 | 10 | 90 | 170 | A | C |
| | 302 | 0 | 10 | 90 | 180 | A | C |
| Ex. Com. 4 | 401 | 72 | 11 | 17 | 170 | D | B |
| | 402 | 72 | 11 | 17 | 180 | D | B |

It can be seen that the bending resistance and the scratch resistance in the examples are superior to those in the comparative examples while maintaining the low-temperature fixability.

The image forming method and the image forming apparatus according to the invention may be usefully used particularly in an electrophotographic method, an electrostatic recording method, and the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A toner comprising a binder resin including:
an amorphous polyester resin (A);
a crystalline polyester resin (B); and
a polyurethane thermoplastic elastomer (C).

2. The toner according to claim 1, wherein a total content of the amorphous polyester resin (A) and the crystalline polyester resin (B) is greater than or equal to about 50% by weight with respect to the total weight of the binder resin.

3. The toner according to claim 1, wherein the crystalline polyester resin (B) is synthesized from an aliphatic polyvalent carboxylic component and an aliphatic polyol component, and the polyurethane thermoplastic elastomer (C) is a thermoplastic polyester urethane synthesized from an organic polyisocyanate and a polyester diol.

4. The toner according to claim 1, wherein the crystalline polyester resin (B) is synthesized from an aliphatic polyvalent carboxylic component and an aliphatic polyol component, and the polyurethane thermoplastic elastomer (C) has a structure represented by Formula (I): 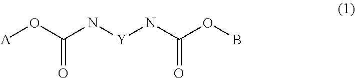
wherein A represents a segment including diisocyanate and glycol, B represents a segment including diisocyanate and polyol, and Y represents a residue of a diisocyanate compound having an urethane bond.

5. A developer comprising:
the toner according to claim 1; and
an insulating carrier liquid.

6. A developer comprising:
the toner according to claim 1; and
a carrier including a magnetic metal or a magnetic oxide.

7. A developer cartridge accommodating the developer according to claim 5.

8. A developer cartridge accommodating the developer according to claim 6.

9. An image forming apparatus comprising:
a latent image holding member;
a latent image forming unit that forms a latent image on a surface of the latent image holding member;
a developing unit that includes a developer holding member and that develops the latent image formed on the surface of the latent image holding member with the developer according to claim 5 held on the surface of the developer holding member to form a toner image;
a transfer unit that transfers the toner image formed on the surface of the latent image holding member to a recording medium; and
a fixing unit that fixes the toner image transferred to the recording medium to the recording medium to form a fixed image.

10. An image forming apparatus comprising:
a latent image holding member;
a latent image forming unit that forms a latent image on a surface of the latent image holding member;
a developing unit that includes a developer holding member and that develops the latent image formed on the surface of the latent image holding member with the developer according to claim 6 held on the surface of the developer holding member to form a toner image;
a transfer unit that transfers the toner image formed on the surface of the latent image holding member to a recording medium; and
a fixing unit that fixes the toner image transferred to the recording medium to the recording medium to form a fixed image.

11. An image forming method comprising:
forming a latent image on a surface of a latent image holding member;
developing the latent image formed on the surface of the latent image holding member with the developer according to claim 5 held on the surface of a developer holding member to form a toner image;
transferring the toner image formed on the surface of the latent image holding member to a recording medium; and
fixing the toner image transferred to the recording medium to the recording medium to form a fixed image.

12. An image forming method comprising:
forming a latent image on a surface of a latent image holding member;
developing the latent image formed on the surface of the latent image holding member with the developer according to claim 6 held on the surface of a developer holding member to form a toner image;
transferring the toner image formed on the surface of the latent image holding member to a recording medium; and fixing the toner image transferred to the recording medium to the recording medium to form a fixed image.
